(19) United States
(12) Patent Application Publication
(10) Pub. No.: US 2013/0133566 A1
(43) Pub. Date: May 30, 2013

(54) METHOD FOR VISUALLY REPRESENTING INFORMATION RELATING TO READINGS OF EQUIPMENT WITH AN INDICATOR

(71) Applicant: Alexander Vladimirovich Asmandijarov, Tomsk (RU)

(72) Inventor: Alexander Vladimirovich Asmandijarov, Tomsk (RU)

(21) Appl. No.: 13/816,025

(22) PCT Filed: Feb. 1, 2011
(86) PCT No.: PCT/RU11/00059

§ 371 Date: Feb. 8, 2013

(30) Foreign Application Priority Data
Aug. 9, 2010 (RU) 2010133346

(51) Int. Cl. G01D 13/22

(52) U.S. Cl. CPC G01D 13/22
USPC 116/303

(57) ABSTRACT

The suggested technical solution relates to a field of measurement technology and may be used for producing the means for visual representation of information about readings of pointer indicators.

The suggested method for visual representation of information about readings of pointer indicators lies in putting a hand into motion over an outer face of a display panel; performing additional rotation of the hand around a longitudinal axis of the hand; and visually reading a value of a reading of the hand based on a location of an end of the hand over the outer face of a scale of the display panel. The technical effect achieved by the suggested technical solution lies in providing a sufficiently high degree of visual representation of information about readings of pointer indicators.

The suggested technical solution relates to a field of measurement technology and may be used for producing the means for visual representation of information with pointer indication, which have a sufficiently high degree of visual representation of information (clearer and more distinct).

Analogous technical solutions are known from, for example, the book “History of clocks from ancient times to the present day,” V. I. Pipunyriova, Moscow, Science, 1982, 261 p., which describes a method for visual representation of information comprising the following set of essential features: putting an hour-hand and a minute-hand into motion over an outer face of a display panel and visually reading values of readings of the hour-hand and the minute-hand based on locations of ends of the hands over the outer face of a scale of the display panel.

The common features of the suggested technical solution and the characterized above analogous technical solution are:
putting at least one hand into motion over the outer face of the display panel;
visually reading a value of a reading of the at least one hand based on a location of the end of the hand over the outer face of the scale of the display panel.

Furthermore, an analogous technical solution is known, for example, from patent RU No. 2237917, that comprises the following set of essential features:
putting an hour-hand, a minute-hand, and a second-hand into motion over an outer face of a display panel;
visually reading values of readings of the hour-hand, the minute-hand, and the second-hand based on locations of ends of the hands over the outer face of a scale of the display panel.

The common features for the suggested technical solution and the analogous technical solution known from patent RU No. 2237917 are:
putting at least one hand into motion over the outer face of the display panel;
visually reading a value of a reading of the at least one hand based on a location of the end of the hand over the outer face of the scale of the display panel.

Furthermore, an analogous technical solution is known, for example, from the specification of author's certificate of the USSR No. 50693 that is chosen as the closest prior art (the prototype) and that comprises the following set of essential features:
putting a hand into motion over an outer face of a display panel;
visually reading a value of a reading of the hand based on a location of an end of the hand over the outer face of a scale of the display panel.
   All the above-listed features of the prototype are common for the suggested technical solution.

Some technical effects cannot be achieved by any of the above-mentioned analogous technical solutions because of insufficient degree of visual representation of information concerning readings of pointer indicators.

The reason why it is impossible to achieve the above-mentioned technical effect is that the established practice pays little attention to providing a higher degree of visual representation (clearer and more distinct) of information when creating means for visual representation of information about readings of pointer indicators.

Taking into consideration the characteristics and analysis of the known analogous technical solutions, the conclusion can be made that the task of creating the means for visual representation of information about readings of pointer indicators having a higher degree of visual representation (clearer and more distinct) of information is of current interest.

The above-mentioned technical effect is achieved by the method for visual representation of information about readings of pointer indicators comprising putting a hand into motion over an outer face of a display panel; visually reading a value of a reading of the hand based on a location of an end of the hand over the outer face of a scale of the display panel; and performing additional rotation of the hand around a longitudinal axis of the hand.

The additional rotation of the hand around the longitudinal axis of the hand allows a more accurate (clearer and more distinct) visual reading of a value of a reading based on a location of the end of the hand over the outer face of a scale of the display panel, since the rotation of the hand around the longitudinal axis of the hand more clearly and distinctly fixes the location of the end of the hand over the outer face of the scale of the display panel and provides a high degree of visual representation of the read value of readings of the pointer indicators. This shows the achievement of the above-mentioned technical effect.

The carried out analysis of the known analogous technical solutions has revealed that none of them comprise either the whole set of the essential features of the suggested technical solution, or its distinctive features, which indicates that the requirements of patentability “novelty” and “inventive step” are met.

The technical essence of the suggested method for visual representation of information about readings of pointer indicators lies in the following:
putting a hand into motion over an outer face of a display panel;
performing additional rotation of the hand around a longitudinal axis of the hand;
visually reading a value of a reading of the hand based on a location of an end of the hand over the outer face of a scale of the display panel.

The suggested method may be realized using various devices. It is suggested to consider an operation of a pointer indicator as an example of the method for visual representation of information about readings of pointer indicators.

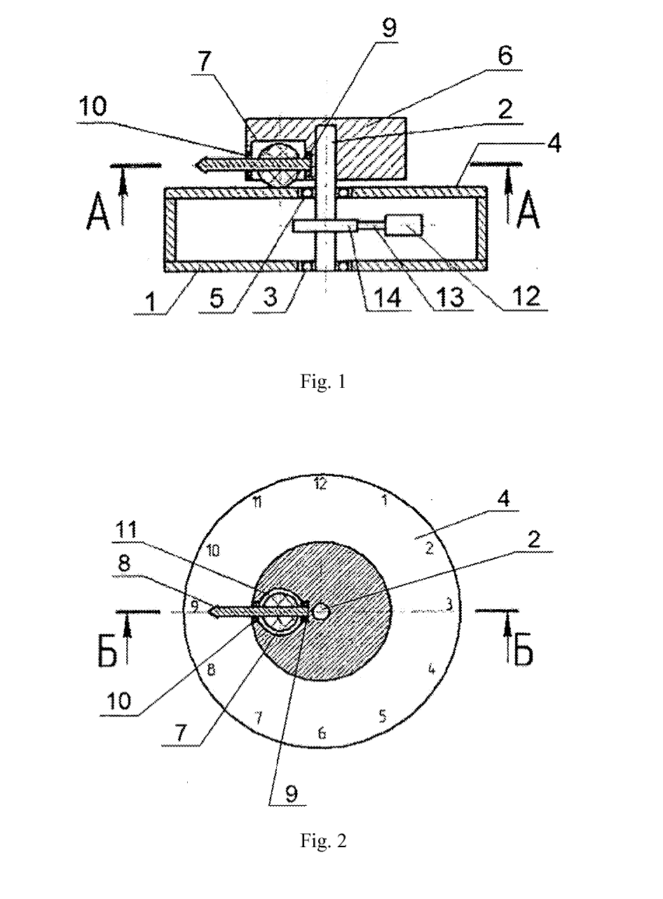

The claimed invention is explained by the drawings, where FIG. 1 shows a pointer indicator, and FIG. 2 shows a top view of the pointer indicator.

A pointer indicator is suggested as a device for visual representation of information about readings of pointer indicators, with the pointer indicator comprising:
a housing 1;
an axis 2 installed and fixed by its lower end in an inner space of an inner race of a bearing 3 fixed by its outer race in an opening made in a lower base of the housing 1;
a display panel 4 made in a form of a ring having a scale of figures placed in an area of the outer face of a circumference of the ring fixed by its central opening on an outer surface of an outer race of a bearing 5 which is fixed on a middle section of an outer surface of the axis 2 by its inner surface of a race and fixed on the housing 1 by outer edges of its circumference;
a holding element 6 in a form of a cylinder having a blind radial opening 7 made on a lower end surface of a cylinder, which is installed and fixed by its central blind opening on an upper end of the axis 2 (the position of the central blind opening of the cylinder is not shown on the drawings);
a hand 8 made, for example, in a form of a cylinder and fixed by one of its ends in an inner race of a bearing 9 which is fixed in an inner side surface of the blind radial opening 7 of the cylinder of the holding element 6 by a surface of its outer race and fixed in the inner space of a bearing 10 by its central part, with the bearing 10 being fixed in an opening made in a side surface of the blind radial opening 7 of the cylinder of the holding element 6 by a surface of its outer race;
a drive for rotation of the hand 8 around its longitudinal (central) axis made in a form of a sphere 11, with the sphere 11 located in the inner space of the blind radial opening 7 of the cylinder of the holding element 6 and fixed by its diametric opening on the corresponding section of the outer surface of the hand 8 and interacting (contacting) by a section of its outer surface with a section of the upper face of the display panel 4;
a drive 12 for rotation of the axis 2 installed inside the housing 1 and engaging, by its lever fork 13, protrusions of a trigger wheel 14 which is fixed by its central opening on the corresponding section of the outer surface of the axis 2, wherein, for example, a drive for a wrist watch published in Polytechnical handbook, publ. house “Sovietskaya encyclopedia,” Moscow, 1980, p. 590, can be used as the drive 12.

The suggested method for visual representation of information about readings of pointer indicators may be explained by considering the operation of the pointer indicator that works as follows.

The axis 2 is put into rotation and, correspondingly, the holding element 6 is put into rotation using the drive 12 for rotation of the axis 2 that engages protrusions of a trigger wheel 14 by a lever fork 13. The holding element 6 starts its rotation over the outer face of the display panel 4 and puts into rotation the sphere 11 (the rotary drive of the hand 8), the rotation is transmitted to the hand 8, and the hand 8 starts its rotation around the longitudinal axis of the hand and, at the same time, performs motion over the outer face of the display panel 4, thereby performing visual reading of a value of reading of the hand based on a location of the end of the hand.

During motion of the second-hand that rotates around its longitudinal axis, one of the possible directions may be given to the rotation (“clockwise”/“counterclockwise” as viewed from the point of view of the general axis of the hands of the clock), both in the direction of movement of the hand on a clock-face and in the opposite direction. A rotation speed of the hand may be different and may correspond to a speed of movement of the hand on the clock-face (similar to a floating movement of a cylinder) or differ upward/downward.

Therefore, the suggested method for visual representation of information about readings of pointer indicators allows clearer and more distinct fixing of a location of an end of a hand over an outer face of a scale of a display panel and provides a high degree of visual representation of the read value of readings of different pointer indicators due to additional rotation of the hand around the longitudinal axis of the hand.

1. A method for visual representation of information about readings of pointer indicators is shown, with the method comprising: putting a hand into motion over an outer face of a display panel and visually reading a value of reading of the hand based on a location of an end of the hand over the outer face of a scale of the display panel, characterized in that the method comprises performing additional rotation of the hand around a longitudinal axis of the hand.
